(19) United States
(12) Patent Application Publication
(10) Pub. No.: US 2006/0213733 A1
(43) Pub. Date: Sep. 28, 2006

(54) Vehicle support system and method of supporting a vehicle body

(76) Inventor: Sadao Masaki, Chiba (JP)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/088,079

(22) Filed: Mar. 23, 2005

(51) Int. Cl. F16F 9/34

(52) U.S. Cl. 188/299.1

(57) ABSTRACT

A support system that is operatively mountable upon a vehicle. The support system has a first component for exerting a force in a first direction along a first line between a support and a mount element on a vehicle to which the support system is operatively mounted. The support system further includes a height adjustment assembly including a case having first and second case parts that are relatively movable to produce a variable force in the first direction upon a mount element on a vehicle to which the support system is operatively mounted.

### BACKGROUND OF THE INVENTION

1. Field of the Invention

This invention relates to support systems on vehicles and, more particularly, to a support system through which the height of the vehicle body can be changed. The invention is further directed to a method of supporting a vehicle body.

2. Background Art

It is known to adjust the height of a vehicle body relative to a support/frame. In one such system, a shock absorber and coil spring are operatively connected to bear upon an upper mount on the vehicle body. A seat is provided on the shock absorber to support the lower end of the coil spring. By moving the seat up and down, a spring force produced on the upper mount can be changed, to thereby change the height of the vehicle body relative to the support/frame.

It is also known to use, in place of the above-described coil spring, a rubber spring that is capable of expanding and contracting in response to a change of air pressure therewithin. By controlling the air pressure, the vehicle body height relative to the support/frame can be selectively changed.

These conventional systems have some inherent drawbacks. Height adjustment by changing the vertical position of the aforementioned spring seat relative to the shock absorber may be a relatively difficult and time consuming operation. Initially, the vehicle must be jacked up to elevate a tire, with which the particular support system is associated, above the vehicle supporting surface. The tire must then be removed to access the spring seat, which may be difficult to reposition in light of the stiffness of the associated coil spring. The coil spring may have to be separately compressed to allow repositioning of the seat.

The use of rubber springs, in place of the coil springs, while adding some convenience, introduces potential performance limitations. Rolling and pitching of the vehicle body are more likely to occur given that the spring rate of the rubber spring is generally lower than that of a coil spring. The vehicle body may tend to reorient undesirably in use. Ride quality and stability may be compromised.

### SUMMARY OF THE INVENTION

In one form, the invention is directed to a support system that is operatively mountable upon a vehicle. The support includes a shock absorber for exerting a force in a first direction along a first line between a support for the shock absorber and a mount element on a vehicle to which the support system is operatively mounted. The support system further includes a height adjustment assembly having a case operatively connected to the shock absorber. The case has first and second case parts. One of the case parts has a force application component. The case parts are movable relative to each other between first and second positions along a second line that is substantially parallel to the first line. The force application component at least one of a) generates a force in the first direction substantially parallel to the first line on a mount element on a vehicle to which the support system is operatively mounted and b) increases a force applied in the first direction substantially parallel to the first line on a mount element on a vehicle to which the support system is operatively mounted, as an incident of the case parts changing from the first relative position into the second relative position. The case has a fluid chamber. The case parts are movable from the first relative position into the second relative position as an incident of changing a pressure of fluid in the fluid chamber.

In one form, the case parts are telescopingly engaged with each other.

In one form, the shock absorber has a housing and the first case part is fixed relative to the shock absorber housing.

The shock absorber has a central axis. In one form, the central axis is substantially parallel to the first line. The fluid chamber extends fully around a part of the shock absorber and the central axis thereof.

The second case part may be cup-shaped with a base wall and an associated annular wall. The shock absorber has a piston rod. The piston rod extends through the base wall and guides movement of the second case part relative to the shock absorber and the first case part.

In one form, the first case part is cup-shaped opening in the first direction. The second case part is cup-shaped opening oppositely to the first direction. First and second facing shoulders are respectively provided on the first and second case parts. The shoulders abut to prevent the first and second case parts from being relatively moved along the second line so as to be fully separated from each other.

A guide ring may be connected to the first case part to define the first shoulder.

The guide ring may be threadably connected to the first case part.

In one form, the second case part has a base wall and an associated annular wall and at least a part of the base wall, annular wall and second shoulder are defined by a single piece.

The force application component may be defined by the base wall.

In one form, the shock absorber has a cylindrical housing with a first central axis. The first case part is cup-shaped with an annular wall extending around a second central axis. The second case part is cup-shaped with an annular wall extending around a third central axis. The first, second and third central axes may be substantially coincident.

In one form, the support system may include a resilient element associated with the shock absorber through which a force is exerted by the shock absorber on a mount element on a vehicle to which the support system is operatively mounted. The force application component acts against a mount element on a vehicle to which the support system is operatively mounted through the resilient element.

In one form, the shock absorber has a piston rod and the resilient element is provided on the piston rod.

The case parts and shock absorber may cooperatively sealingly bound the fluid chamber.

The support system may be provided in combination with a vehicle to which the support system is mounted. The vehicle has a support for the shock absorber and a mount element against which a force is exerted by the shock absorber.

The support system may further include a coil spring that surrounds the height adjustment assembly and acts between a seat on the support assembly and mount element.

In one form, the seat is repositionable in a direction parallel to the first line to vary a force exerted by the coil spring between the seat and the mount element.

In one form, the shock absorber has a piston rod that is movable through a first stroke length and the case parts are relatively movable through a second stroke length. The second stroke length may be equal to or less than the first stroke length.

The invention is further directed to a support system that is operatively mountable upon a vehicle. The support system has a first component for exerting a force in a first direction along a first line between a support and a mount element on a vehicle to which the support system is operatively mounted. The support system further includes a height adjustment assembly including a case having first and second case parts that are relatively movable to produce a variable force in the first direction upon a mount element on a vehicle to which the support system is operatively mounted.

The height adjustment assembly may further include a fluid chamber. The first and second case parts are movable as an incident of changing a pressure of fluid in the fluid chamber.

The support system may further include a coil spring that acts between a seat on the support assembly and a mount element on a vehicle to which the support system is operatively mounted.

The first component may be a shock absorber. The support system may be provided in combination with a vehicle to which the support system is operatively mounted and having a support for the shock absorber and a mount element against which a force is exerted by the shock absorber.

The invention is further directed to a method of supporting a body of a vehicle having a support and a mount element. The method includes the steps of: exerting a force between the support and mount element using a shock absorber with an extendable piston rod; providing a case with cooperating first and second case parts, with the first case part operatively connected to the shock absorber and the second case part movable relative to the first case part to exert a variable force upon the mount element; and changing pressure of a fluid acting between the first and second case parts to vary a force exerted through the second case part upon the mount element.

The method may further include the step of generating a force upon the mount element through a coil spring acting between a seat on the case and the mount element.

The method may further include the step of repositioning the seat to thereby vary a force produced by the coil spring upon the mount element.

### BRIEF DESCRIPTION OF THE INVENTION

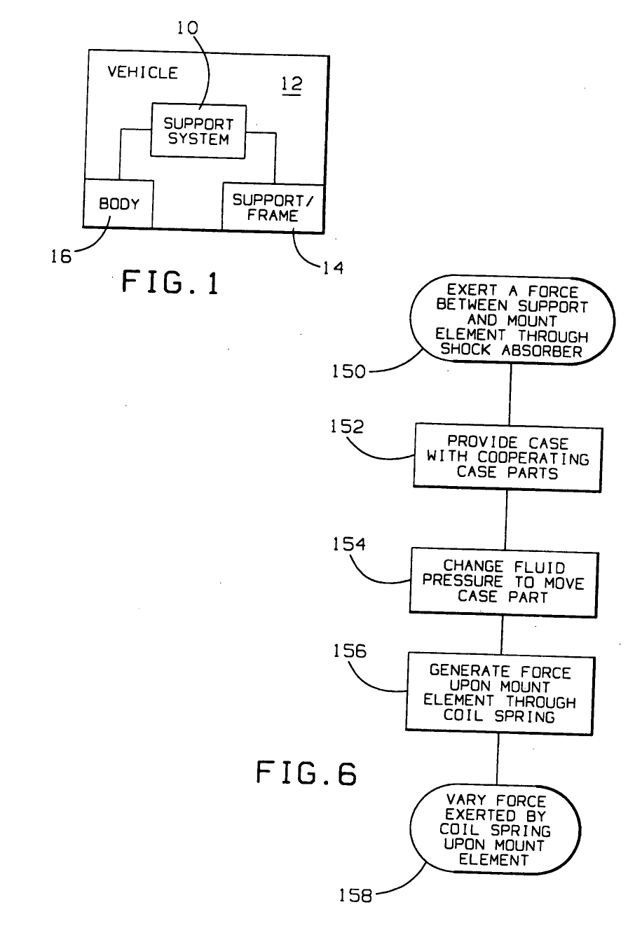

FIG. 1 is a schematic representation of a vehicle including a support system, according to the present invention, acting between a vehicle body and a support/frame;

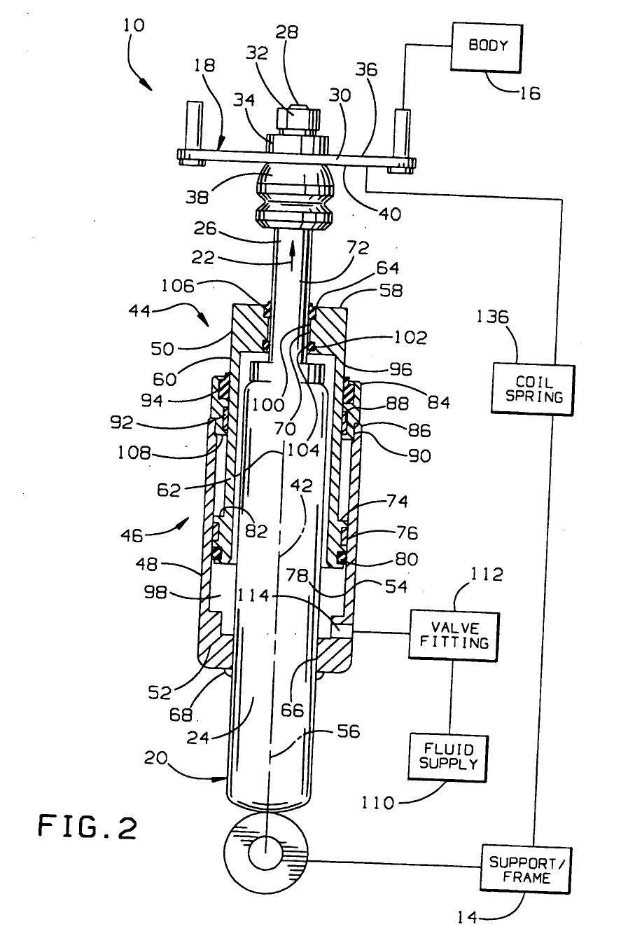

FIG. 2 is a partially schematic, partial cross-sectional view of one form of the support system shown schematically in FIG. 1, including a shock absorber and height adjustment assembly, according to the present invention, cooperatively acting between the vehicle support/frame and a mount element on the body and with the height adjustment assembly consisting of cooperating case parts in a first relative position;

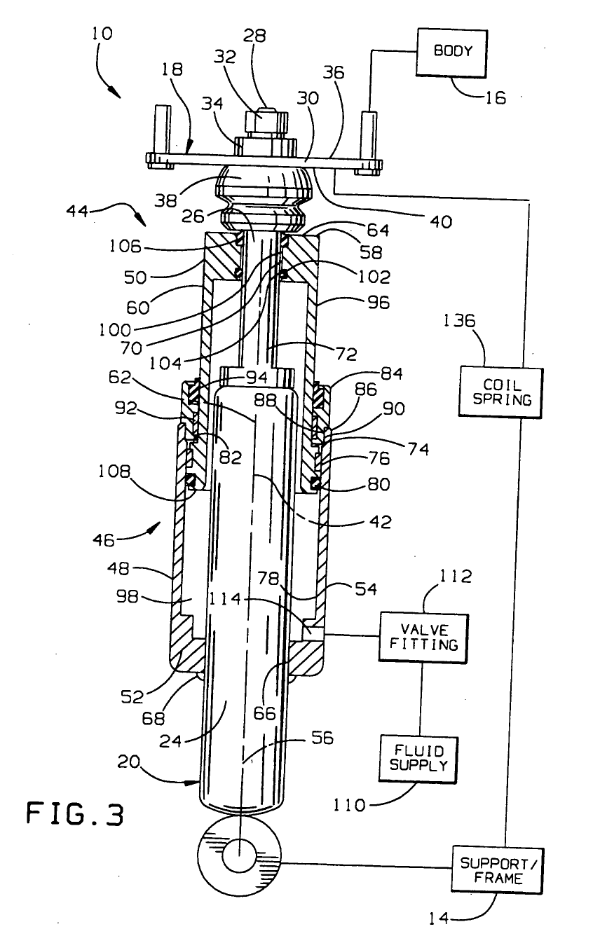

FIG. 3 is a view as in FIG. 2 wherein the case parts are in a second relative position to exert a lifting force upon the mount element;

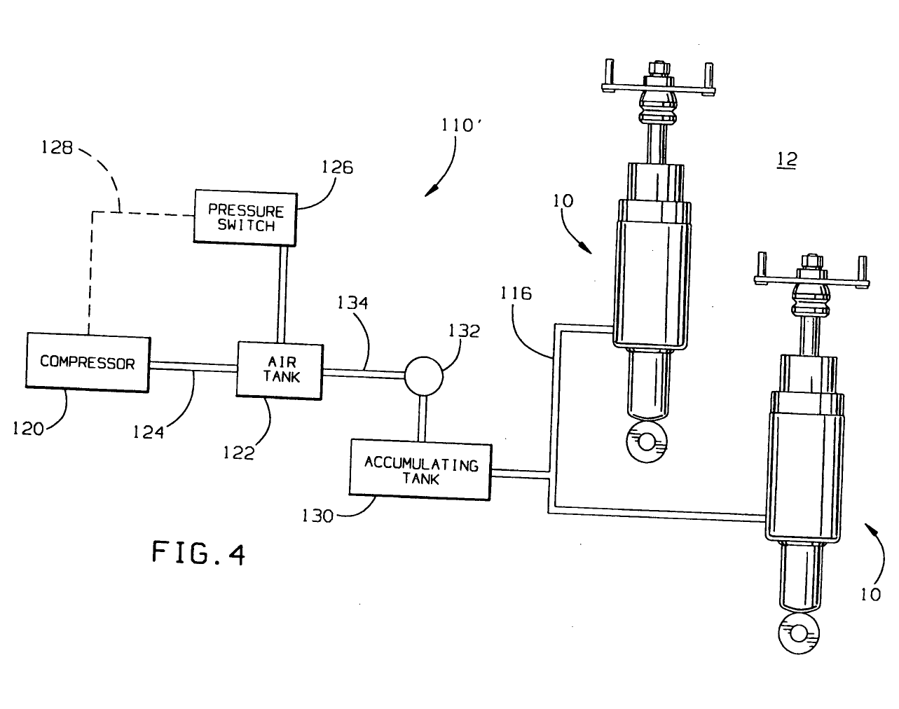

FIG. 4 is a schematic representation of a fluid supply for separate support systems on a vehicle;

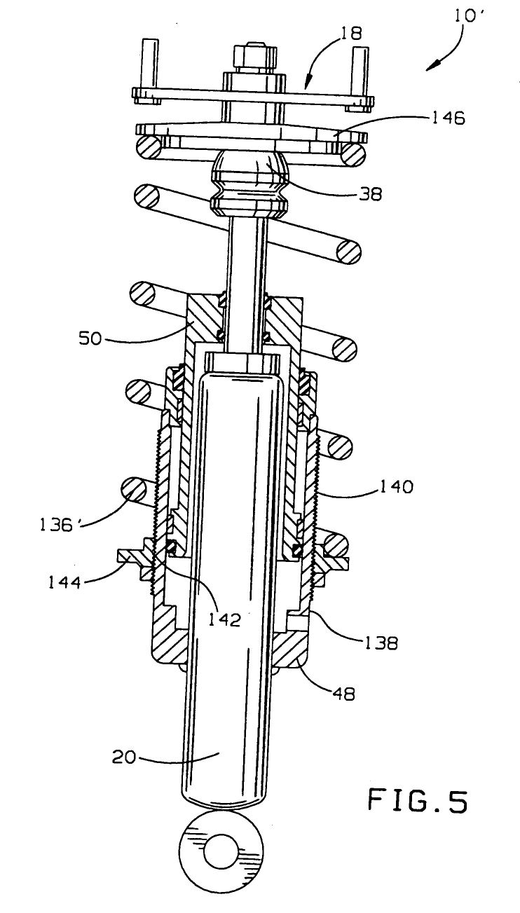

FIG. 5 is a view as in FIGS. 2 and 3 wherein a coil spring surrounds the shock absorber and height adjustment assembly; and

FIG. 6 is a flow diagram representation of one method for supporting a body of a vehicle, according to the present invention.

### DETAILED DESCRIPTION OF THE INVENTION

Referring initially to FIG. 1, a support system, according to the present invention, is shown generically at 10 on a vehicle 12. The support system 10 acts between a support/frame 14 and a body 16. Typically, the support/frame will be provided with a wheel in the vicinity of where each support system 10 is located. The precise nature of the vehicle 12 is not critical to the present invention. The vehicle 12 may be a two-wheeled vehicle or have four or more wheels. Mechanisms other than wheels for the support/frame 14 are also contemplated.

Referring to FIG. 2, one form of support system 10 is shown acting between the vehicle support/frame 14 and an upper mount element 18 on the body 16. The support system 10 consists of a shock absorber 20 for exerting a force in a first direction along a first line, as indicated by the arrow 22, between the support/frame 14 and mount element 18. The shock absorber 20 has a housing 24 and an extendable piston rod 26. A free end 28 of the piston rod 26 is extended fully through a plate 30 on the mount element 18 and is secured against being separated from the plate 30, through downward movement relative thereto, by a nut 32 and a spacer 34 between the plate 30 and nut 32. The spacer 34 bears against one side 36 of the plate 18. A resilient element/bumper 38 is attached to the piston rod 26 at the side 40 of the plate 30, opposite the side 36. The piston rod 26 applies an upward force on the mount element 18 through the resilient element/bumper 38. The shock absorber 20 has a central axis 42 that is parallel to the line of force application indicated by the arrow 22.

The support system 10 further includes a height adjustment assembly at 44. The height adjustment assembly 44 consists of a case 46 that is operatively connected to the shock absorber 20. The case consists of first and second case parts 48, 50, respectively.

The first case part 48 is cup-shaped, opening in the first direction, as indicated by the arrow 22. The first case part 48 has a base wall 52 and an integral annular wall 54 with a central axis 56.

The second case part 50 is cup-shaped opening oppositely to the first direction, as indicated by the arrow 22. The second case part 50 has a base wall 58 and an integral annular wall 60 with a central axis 62.

The case parts 48, 50 are telescopingly engaged with, and movable relative to, each other between a first position, shown in FIG. 2, and a second position, shown in FIG. 3. In FIG. 2, a force application component 64, in this case a surface on the base wall 58, is spaced downwardly from the resilient element/bumper 38. With the case parts 48, 50 in the second relative position, an upward force is exerted by the force application component 64 upon the resilient element/bumper 38, to thereby produce a lifting force on the upper mount element 18. As will be explained below, the case parts 48, 50 are movable between different relative positions to either a) move the force application component 64 into engagement with the resilient element 38 to generate an upward force on the mount element 18 or b) increase a force applied upon the resilient element 38, and thereby the mount element 18 in engagement therewith.

The shock absorber 20 and height adjustment assembly 44 are operatively interconnected as follows. The base wall 52 of the first case part 48 has a through opening 66 which closely receives the shock absorber housing 24. An annular weld 68 fixes the first case part 48 to the shock absorber housing 24 and defines a fluid seal between the base wall 52 and shock absorber housing 24.

The annular walls 54, 60 are relatively dimensioned so that the annular wall 60 resides within the annular wall 54. This arrangement could, however, be reversed. The base wall 58 on the second case part 50 has a through opening 70 that is slightly larger than the diameter of the outer surface 72 of the piston rod 26. With this arrangement, the central axes 56, 62 of the case part walls 54, 60 and central axis 42 of the housing 24 are substantially coincident.

The second case part 50 is guided in sliding vertical movement by the piston rod 26 and through cooperation between radially facing surfaces on the case parts 48, 50, as hereinafter described.

The annular wall 60 on the second case part 50 has a radially enlarged bead 74. The bead 74 is radially undercut to receive a wear ring 76 that acts between the bead 74 and a radially inwardly facing surface 78 on the annular wall 54 on the first case part 48. The bead 74 is further undercut to accept a sealing ring 80 that is compressed between the bead 74 and the surface 78. The bead 74 further defines an annular shoulder 82 that faces in the first direction, as indicated by the arrow 22.

A guide ring 84 is connected to the annular wall 54 on the first case part 48 at an upper free end 86 thereon. Cooperating internal and external threads 88, 90 on the annular wall 54 and guide ring 84 cooperate to allow the guide ring 84 to be releasably screwed into the operative position shown in FIGS. 2 and 3.

The radially inwardly facing portion of the guide ring 84 is undercut to accommodate a wear ring 92 and a dust sealing ring 94. The wear ring 92 guides relative sliding movement between the upper region of the annular wall 54 on the first case part 48 and the outside surface 96 on the second case part 50. The dust sealing ring 94 prevents migration of foreign matter to between the dust sealing ring 94 and the outside surface 96 of the second case part 50.

With the shock absorber 20 and first and second case parts 48, 50 in the operative position of FIGS. 2 and 3, an annular fluid chamber 98 extends around the shock absorber housing 94 and is bounded by the shock absorber 20 and the first and second case parts 48, 50. The aforementioned sealing ring 80 maintains a fluid tight relationship between the bead 74 and inside surface 78 of the annular wall 54.

Escape of fluid from the chamber between the outer surface 72 of the piston rod 26 and the surface 100 bounding the through opening 70 in the base wall 58 is prevented by a sealing ring 102 seated in an undercut 104 through the surface 100. A dust sealing ring 106 is also interposed between the piston rod 26 and surrounding surface 100 to prevent migration of foreign matter into the space between the surfaces 72, 100 and therefrom into the fluid chamber 98.

In addition to its guide function, the guide ring 84 also defines an annular shoulder 108 that faces the shoulder 82 upon the bead 74 on the second case part 50. The shoulders 108, 82 abut to prevent full separation of the case parts 48, 50 as the case parts are moved away from each other parallel to the line indicated by the arrow 22.

To maintain a fluid tight seal in the chamber 98, a number of different materials and constructions can be utilized. If necessary, a material can be used to enhance the seal at the weld 68 if it is not fully fluid right. The sealing rings 80, 102 may be O-rings as shown. Alternatively, pneumatic or hydraulic packing can be utilized at these locations.

The fluid chamber 98 is filled with a fluid that may be a gas or a liquid, i.e. air, operating oil, antifreeze oil, etc. The fluid may be pressurized by a compressor, water pump, oil pump, or the like.

As shown in FIGS. 2 and 3, fluid is introduced to the chamber 98 from a supply 110 of the fluid through a valve fitting 112 mounted in a port 114 defined in the annular wall 54 of the first case part 48.

A more detailed showing of one form of the fluid supply is shown at 110′ in FIG. 4. In FIG. 4, a vehicle 12 is shown with two associated support systems 10, as previously described. A conduit/hose 116 communicates simultaneously with the support systems 10 through appropriate fittings 112, shown in FIG. 2 but not in FIG. 4. For purposes of explanation, the fluid supply 110′ will be described with respect to the use of air.

The supply 110′ consists of a compressor 120 and air tank 122 connected through a conduit/hose 124. Air compressed by the compressor 120 is accumulated in the air tank 122. A pressure switch 126 in communication with the air tank 122 is operable in conventional manner to maintain a desired range of air pressure within the tank 122. The pressure switch 126 is connected to the compressor through an appropriate line 128 that allows this control. The compressor 120 will be operated until a predetermined upper pressure is arrived at in the air tank 122, at which point the pressure switch 126 will cause the compressor 120 to be stopped. An accumulating tank 130 is provided to be in direct communication through the conduit/hose 116 with the support systems 10. A regulator 132 is interposed in a line/conduit 134 between the air tank 122 and the accumulating tank 130 so that an appropriate pressure is maintained in the accumulating tank 130.

With the arrangement shown in FIGS. 2 and 3, the shock absorber 20 and support system 10 cooperate to support the vehicle body 16 and allow a height adjustment capability. In the embodiment shown, a coil spring 136 additionally acts between the support/frame 14 and the mount element 18 on the body 16. This spring 136 may produce a force in a line that is spaced from and/or non-parallel to, the line of force application indicated by the arrow 22.

In FIG. 5, a modified form of support system is shown at 10′, to include a shock absorber 20 and second case part 50, as described above. A corresponding first case part 48′ is configured similarly to the case part 48, with the exception that an external surface 138 thereon has threads 140 to cooperate with female threads 142 on a lower seat 144 for a coil spring 136′ corresponding to the spring 136 in FIGS. 2 and 3. The coil spring 136′ surrounds the shock absorber 20 and case parts 48′, 50 and acts between the lower seat 144 and an upper seat 146 connected to the mount element 18. In this embodiment, the resilient element/bumper 38 acts against the upper seat 146, which in turn acts against the upper mount element 18.

With this arrangement, the lower seat 144 can be vertically adjusted to vary the spring force exerted by the coil spring 136′ upon the upper seat 146.

With the above-described structures, the piston rod 26 is movable through a first stroke length. The case parts 48, 50 are relatively movable through a second stroke length. The second stroke length is equal to or less than the first stroke length.

Many variations from the structure described above are contemplated. For example, the second case part 50 is constructed so that the base wall 58, annular wall 60 and shoulder 82 are formed as one piece. However, this is not a requirement.

Additionally, the port 114 for the valve fitting 112 may be provided at other locations than that shown, such as different locations on the first case part 48, or on the second case part 50, such as on the base wall 58.

According to the invention, a method can be practiced, as shown in flow diagram form in FIG. 6, to support a body on a vehicle having a support and mount element, described above, or otherwise configured. As shown at block 150, a force is exerted between a support and mount element through a shock absorber. As shown at block 152, a case is provided with cooperating parts, with the first case part operatively connected to the shock absorber and the second case part movable relative to the first case part to exert a variable force upon the mount element. As shown at block 154, fluid pressure acting between the cooperating case parts is changed to move the second case part relative to the first case part to vary a force exerted to the second case part upon the mount element.

The method may further include a step, as shown at block 156, of generating a force upon the mount element through a coil spring. As shown at block 158, the force exerted by the coil spring may be varied.

Since the support system 10 adjusts the vehicle body height by generating an elastic force at the shock absorber, the inventive concept may also be used for suspensions utilizing leaf springs.

Since the support system cooperatively uses the height adjustment assembly 44 in combination with the spring 136, 136′, as well as the shock absorber 20, the overall system prevents rolling and pitching of the vehicle potentially more effectively than a system utilizing an air spring including a rubber spring component. The moving case part 50 produces a resilient lifting force and thus functions as an auxiliary spring to change the combined effective spring rate. Potentially good comfort and stability are afforded during driving. Additionally, since there is redundant support of the vehicle body 16, the vehicle 12 is in a “fail safe” mode. That is, a failure of the coil spring 136, 136′ or shock absorber 20 will be compensated for by the support system 10.

The foregoing disclosure of specific embodiments is intended to be illustrative of the broad concepts comprehended by the invention.

1. A support system that is operatively mountable upon a vehicle, the support system comprising:
a shock absorber for exerting a force in a first direction along a first line between a support for the shock absorber and a mount element on a vehicle to which the support system is operatively mounted; and
a height adjustment assembly comprising a case operatively connected to the shock absorber and comprising first and second case parts,
one of the case parts comprising a force application component,
the case parts movable relative to each other between first and second positions along a second line that is substantially parallel to the first line,
the force application component at least one of a) generating a force in the first direction substantially parallel to the first line on a mount element on a vehicle to which the support system is operatively mounted and b) increasing a force applied in the first direction substantially parallel to the first line on a mount element on a vehicle to which the support system is operatively mounted, as an incident of the case parts changing from the first relative position into the second relative position,
the case comprising a fluid chamber,
the case parts movable from the first relative position into the second relative position as an incident of changing a pressure of fluid in the fluid chamber.

2. The support system for a vehicle according to claim 1 wherein the case parts are telescopingly engaged, with each other.

3. The support system for a vehicle according to 2 wherein the shock absorber has a housing and the first case part is fixed relative to the shock absorber housing.

4. The support system for a vehicle according to 2 wherein the shock absorber has a central axis that is substantially parallel to the first line and the fluid chamber extends fully around a part of the shock absorber and the central axis of the shock absorber.

5. The support system for a vehicle according to 2 wherein the second case part is cup-shaped with a base wall and an associated annular wall, the shock absorber has a piston rod, and the piston rod extends through the base wall and guides movement of the second case part relative to the shock absorber and the first case part.

6. The support system for a vehicle according to 2 wherein the first case part is cup-shaped opening in the first direction, the second case part is cup-shaped opening oppositely to the first direction, and there are first and second facing shoulders respectively on the first and second case parts that abut to prevent the first and second case parts from being relatively moved along the second line so as to be fully separated from each other.

7. The support system for a vehicle according to 6 wherein a guide ring is connected to the first case part to define the first shoulder.

8. The support system for a vehicle according to 7 wherein the guide ring is threadably connected to the first case part.

9. The support system for a vehicle according to 8 wherein the second case part has a base wall and an associated annular wall and at least a part of the base wall, annular wall and second shoulder are defined by a single piece.

10. The support system for a vehicle according to 5 wherein the force application component is defined by the base wall.

11. The support system for a vehicle according to 2 wherein the shock absorber has a cylindrical housing with a first central axis, the first case part is cup-shaped with an annular wall extending around a second central axis, the second case part is cup-shaped with an annular wall extending around a third central axis, and the first, second and third central axes are substantially coincident.

12. The support system for a vehicle according to 2 further comprising a resilient element associated with the shock absorber through which a force is exerted by the shock absorber on a mount element on a vehicle to which the support system is operatively mounted, and the force application component acts against a mount element on a vehicle to which the support system is operatively mounted through the resilient element.

13. The support system for a vehicle according to 12 wherein the shock absorber comprises a piston rod and the resilient element is provided on the piston rod.

14. The support system for a vehicle according to 2 wherein the case parts and shock absorber cooperatively sealingly bound the fluid chamber.

15. The support system for a vehicle according to 2 in combination with a vehicle to which the support system is operatively mounted and comprising a support for the shock absorber and a mount element against which a force is exerted by the shock absorber.

16. The support system for a vehicle according to 15 wherein the support system further comprises a coil spring that surrounds the height adjustment assembly and acts between a seat on the support assembly and mount element.

17. The support system for a vehicle according to 16 wherein the seat is repositionable in a direction parallel to the first line to vary a force exerted by the coil spring between the seat and the mount element.

18. The support system for a vehicle according to 2 wherein the shock absorber has a piston rod that is movable through a first stroke length, the case parts are relatively movable through a second stroke length, and the second stroke length is equal to or less than the first stroke length.

19. A support system that is operatively mountable upon a vehicle, the support system comprising:
a first component for exerting a force in a first direction along a first line between a support and a mount element on a vehicle to which the support system is operatively mounted; and
a height adjustment assembly comprising a case comprising first and second case parts that are relatively movable to produce a variable force in the first direction upon a mount element on a vehicle to which the support system is operatively mounted.

20. The support system for a vehicle according to 19 wherein the height adjustment assembly further comprises a fluid chamber and the first and second case parts are relatively movable as an incident of changing a pressure of a fluid in the fluid chamber.

21. The support system for a vehicle according to 20 further comprising a coil spring that acts between a seat on the support assembly and a mount element on a vehicle to which the support system is operatively mounted.

22. The support system for a vehicle according to 21 wherein the first component comprises a shock absorber and the case parts and shock absorber cooperatively sealingly bound the fluid chamber.

23. A method of supporting a body of a vehicle comprising a support and a mount element, the method comprising the steps of:
exerting a force between the support and mount element using a shock absorber with an extendable piston rod;
providing a case with cooperating first and second case parts with the first case part operatively connected to the shock absorber and the second case part movable relative to the first case part to exert a variable force upon the mount element; and
changing pressure of a fluid acting between the first and second case parts to vary a force exerted through the second case part upon the mount element.

24. The method of supporting a body of a vehicle according to claim 23 further comprising the step of generating a force upon the mount element through a coil spring acting between the case and the mount element.

25. the method of supporting a body of a vehicle according to claim 24 further comprising the step of repositioning the seat to thereby vary a force produced by the coil spring upon the mount element.
